(19) United States
(12) Patent Application Publication
(10) Pub. No.: US 2026/0207001 A1
(43) Pub. Date: Jul. 23, 2026

(54) INFRARED COOKING DEVICE WITH IMPROVED MOVEMENT FUNCTIONS

(71) Applicant: TANATAR KALIP PRES ISLERI SANAYI VE TICARET LIMITED SIRKETI, Eskisehir (TR)

(72) Inventors: Sedat HALAC, Eskisehir (TR); Fatma UNUGUR, Eskisehir (TR)

(73) Assignee: TANATAR KALIP PRES ISLERI SANAYI VE TICARET LIMITED SIRKETI, Eskisehir (TR)

(21) Appl. No.: 19/138,110

(22) PCT Filed: Jan. 23, 2023
(86) PCT No.: PCT/TR2023/050051

§ 371 Date: Jun. 12, 2025

(30) Foreign Application Priority Data
Dec. 30, 2022 (TR) 2022/021695

(51) Int. Cl. A47J 36/24; A47J 27/00; A47J 27/13; A47J 36/32; F24C 15/00

(52) U.S. Cl. CPC A47J 36/2488; A47J 27/004; A47J 27/13; A47J 36/32; F24C 15/005

(57) ABSTRACT

The provided is a cooking device including at least one bottom plate and at least one top plate positioned on a chassis, and at least one infrared heat source positioned on at least one of the said top plate and said bottom plate to allow heating/cooking of a food product in a cooking space. The cooking device includes a movement mechanism in which at least one of the bottom plate and the top plate is associated to be moved relative to the other in a vertical axis and the bottom plate is configured to be at least partially moved in a horizontal axis to position it in a cooking position and a serving position.

### TECHNICAL FIELD

The invention relates to a cooking device comprising at least one bottom plate and at least one top plate positioned on a chassis, and at least one infrared heat source positioned on at least one of the said top plate and said bottom plate to allow heating/cooking of a food product in a cooking space.

### BACKGROUND

Foods are often heated to facilitate digestion and to make them taste better. In conventional heating, achieved by burning fuels or by an electric resistance heater, heat is generated outside the object to be heated and transferred to the food product by hot air convection or thermal transmission. Currently, in addition to these traditional heating methods, infrared radiation has also begun to be used in cooking. Certain properties of infrared radiation, such as efficiency, wavelength, and reflectivity, make it more effective than other applications for cooking. Cooking with infrared radiation also increases its preferability due to its higher thermal efficiency and fast cooking time compared to traditional cooking.

The 780 nm-1 mm range of infrared waves is considered as cooking for foods. Infrared, that is, infrared radiation is carried to the surface of the product by radiation and in general, it heats the surface and cooks. With the action of molecules on the surface of the food, there is an increase in heat and there is no lighting feature. It is directly related to the wavelength of the radiation to be used. Short wavelength lamps can also be preferred to cook the interior parts of food products. This value is approximately 1100 nm. Different types of lamps provide an infrared wave source to improve the heat effect on food.

Application No. CN203458242U, which is in the state of the art, relates to an oven used for cooking food. The product of the invention consists of an oven comprising a wall forming a room; a frame fixed outside the wall; and a heating device comprising infrared heaters disposed inside the frame. There is a thermocouple in the oven. The wall is a detachable wall to reflect infrared rays. The grid frame is removable. Thus, it allows food residues to be washed and cleaned instantly.

Application No. US2014000463A1, which is in the state of the art, is related to a grill or barbecue-type cooking device. The device of the invention comprises a frame supporting a cooking surface on which foodstuffs to be cooked can be placed and an infrared heating surface arranged opposite the said cooking surface. The grill referred to as the cooking frame in the device allows adjustment at the desired slope to be less than 90°. The bottom plate of the grille can be removed for easy cleaning. The bottom plate can be made of stainless steel or poorly conductive material.

Although there are currently systems using infrared filaments;
There is no product about cooking different types of food products at once,
There are no solutions for the effective use of cooking time,
There is no solution other than changing the wavelength to adjust the cooking speed of food products,
The mobility in cooking devices is not sufficient to meet the needs of the user and does not contain practical solutions,
In existing systems, either the cooking time is long or in infrared systems, the inside of the food product is not cooked and causes taste problems.

As a result, all the above-mentioned problems have made it necessary to innovate in the relevant technical field.

### BRIEF DESCRIPTION OF THE INVENTION

The present invention relates to a cooking device for eliminating the above-mentioned disadvantages and bringing new advantages to the relevant technical field.

The main object of the invention is to present a cooking device that allows fast and practical cooking of food products by infrared radiation.

An object of the invention is to present an infrared-based cooking device, wherein the desired temperature can be adjusted during cooking and serviceability is ensured.

Another object of the invention is to present an infrared-based cooking device with improved mobility.

An object of the invention is to present an infrared-based cooking device that allows cooking different food products at the same time.

Another object of the invention is to present an infrared-based cooking device that can cook at different temperatures.

In order to realize all the above-mentioned objectives and those that will emerge from the detailed description below, the present invention is a cooking device comprising at least one bottom plate and at least one top plate positioned on a chassis, and at least one infrared heat source positioned on at least one of the said top plate and said bottom plate to allow heating/cooking of a food product in a cooking space. Accordingly, its novelty is that at least one of the bottom plate and the top plate comprises a movement mechanism with which it is associated for moving in a vertical axis relative to the other and that the bottom plate is configured to be positioned in a cooking position and a serving position by at least partially moving it along a horizontal axis. This enables adjustment of the cooking function by moving between the top plate and the bottom plate and ease of service with the movement of the bottom plate.

A possible embodiment of the invention is characterized in that the movement mechanism has moved the bottom plate in the vertical axis. This ensures that the top plate remains stationary and the bottom plate is positioned relative to the top plate.

Another possible embodiment of the invention is characterized in that it comprises at least one tray slot on the bottom plate and a tray insertable in the said tray slot. This allows the tray to be separated from the bottom plate and used directly in the service.

Another possible embodiment of the invention is characterized in that the said tray is made of at least one of stainless steel, granite coating on aluminum casting, enamel coating on iron casting, heat-resistant porcelain, or ceramic. This enables the use of different types of trays for different cooking situations.

Another possible embodiment of the invention is characterized in that the grid disposed inside the tray is made of stainless steel or nickel-plated steel wire. This enables the use of different types of grills for different cooking situations.

Another possible embodiment of the invention is characterized in that it comprises at least one control unit for controlling the movement mechanism and a display panel for user guidance. This allows the cooking device to be managed by the user.

### BRIEF DESCRIPTION OF THE FIGURES

FIG. 1 shows a representative perspective view of the cooking device of the invention.

FIG. 2 shows a representative side cross-sectional view of the cooking device of the invention.

FIG. 3 shows a representative perspective view showing the movement of the cooking device of the invention on the vertical axis.

FIG. 4 shows a representative perspective view of the cooking device of the invention in the serving position.

FIG. 5 shows a representative perspective view of the cooking device of the invention.

FIG. 6 shows a representative bottom view showing the infrared heat source in the cooking device of the invention.

### DETAILED DESCRIPTION OF THE INVENTION

In this detailed description, the subject matter of the invention is explained only by means of examples that will not have any limiting effect for a better understanding of the subject matter.

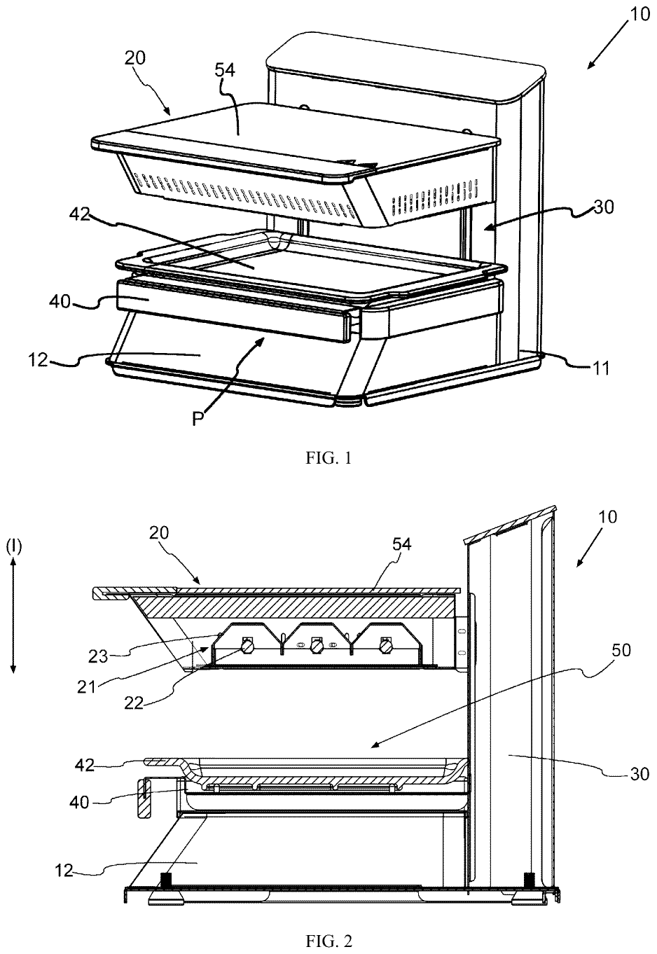

FIG. 1 shows a representative perspective view of the cooking device (10) of the invention. Accordingly, the cooking device (10) of the invention is configured to bake with infrared, that is, infrared radiation. Infrared heating (infrared radiation heating) is a method used as a heating or drying method in the food industry. It has advantages such as minimal damage to food quality, fast heating, and high energy efficiency. The cost of infrared heating is low, and cooking time is short. Application areas IR is an effective food processing technology. In this technology, foodstuffs are subjected to high-temperature processing for a short time.

FIG. 2 shows a representative side cross-sectional view of the cooking device (10) of the invention. Accordingly, the cooking device (10) has at least one chassis (11). Various components are positioned on the chassis (11) and work synchronously with each other, allowing the food product to be cooked. On the chassis (11) there is at least one bottom plate (40) and at least one top plate (20). The food product is cooked by positioning on at least one of the bottom plate (40) and the top plate (20). In a preferred embodiment of the invention, the food product is positioned on the bottom plate (40) and is heated/cooked by an infrared heat source (21) located on the top plate (20). The infrared heat source (21) mentioned in the invention is essentially a carbon filament (22). The carbon filament (22) in the infrared heat source (21) radiates heat to the environment on the basis of its irradiation. In this way, the food product positioned on the bottom plate (40) is heated. The infrared heat source (21) has a plurality of carbon filaments (22) depending on the capacity expected from the cooking device (10). The carbon filament (22) is preferably in the range of 3 to 10 pieces on the cooking device (10). These carbon filaments (22) cook through the infrared rays they emit. The carbon filaments (22) may be associated with reflectors (23) that are individually formed so that they can give infrared radiation to the cooking space (50). By means of the reflectors (23), it is ensured that the focus can be made on the food products in the cooking space (50).

In the cooking device (1), at least one of the bottom plate (40) and the top plate (20) is configured to be zoomable relative to the other. By moving at least one of the bottom plate (40) and the top plate (20) relative to the other, the cooking speed and efficiency can be adjusted. In a possible embodiment of the invention, the bottom plate (40) is configured to be zoomed in and out towards the top plate (20). In this way, the cooking space (50) can also be adjusted according to the user's personalized position according to the user's needs. In addition, thanks to the fact that the bottom plate (40) can be moved relative to the top plate (20), the user can also be provided with convenience for service.

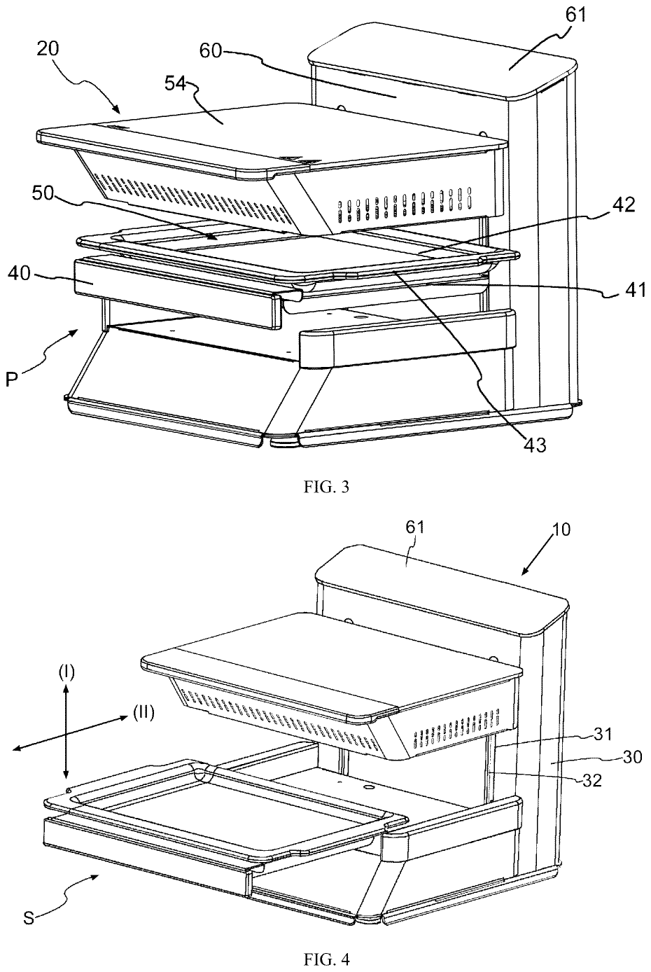

FIG. 3 shows a representative perspective view showing the movement of the cooking device (10) of the invention on the vertical axis (I). Accordingly, the cooking device (10) has at least one movement mechanism (30) for moving at least one of the bottom plate (40) and the top plate (20) towards the other. The bottom plate (40) and the top plate (20) are essentially positioned on a vertical axis (I), and their movement relative to each other is also made on the vertical axis (I). The movement mechanism (30) is essentially configured to move the bottom plate (40) in the vertical axis (I) towards the top plate (20). For this purpose, there may be a slot (31) on the movement mechanism (30) that allows the connection of the bottom plate (40) and at least one skid (32) in the said slot (31) that allows movement towards the top plate (20). There may be two different options for moving the movement mechanism (30). In a possible embodiment of the invention, the movement mechanism (30) may have a user-controlled movement substructure. For example, the user can manually position the bottom plate (40) in the desired position by moving it manually. In alternative embodiments of the invention, the movement mechanism (30) may be associated with a drive. By means of this drive, it can be made by the control unit (60) in a user-oriented or automatic sensing manner. The movement mechanism (30) can be in a structure that can automatically detect the amount of cooking and adjust the distance between the bottom plate (40) and the top plate (20) accordingly.

FIG. 4 shows a representative perspective view of the cooking device (10) of the invention at the serving position(S). Accordingly, the bottom plate (40) is configured to be at least partially movable in a horizontal axis (II) as well as in the vertical axis (I). For this, the bottom plate (40) is configured to slip on at least one base (12). In this way, it is ensured that the bottom plate (40) can be displaced between a cooking position (P) and a serving position(S). The cooking position (P) is the position in which the bottom plate (40) and the top plate (20) are concentrically positioned vertically. The serving position(S) is the position in which the bottom plate (40) is moved in the vertical axis (I) relative to the top plate (20). In the cooking position (P), while cooking the food product, in the serving position(S), it is possible to easily perform operational steps such as placing or discharging the food products on the bottom plate (40). When the bottom plate (40) is moved to the serving position(S), the carbon filament (22) that provides the cooking process is automatically de-energized.

FIG. 5 shows a representative perspective view of the cooking device (10) of the invention. Accordingly, there is at least one tray slot (41) on the bottom plate (40). At least one tray (42) may be positioned in the said tray slot (41) for placing food products while cooking. The tray slot (41) may be formed in a predetermined manner depending on the form of the tray (42). The tray slot (41) is essentially in the form of a frame. On the other hand, the tray (42) is placed in this frame-shaped tray slot (41) with the side portions it has. The tray (42) mentioned in the invention may preferably be made of a material such as stainless steel, granite coating on aluminum casting, enamel coating on iron casting, heat-resistant porcelain, or ceramic. In this way, depending on the expected working performance of the tray (42), it is also ensured that different trays (42) are seated in the tray slot (41). Thanks to the separability of the tray (42) from the tray slot (41), it can be ensured that the tray (42) is washed after cooking and served directly after cooking. In addition, the flank (43) of the tray (42) protects the bottom plate (40) against wastes such as oil during cooking. In addition, if a grid is placed in the tray (42), the oil flowing as a result of cooking flows into the tray (42) and the tray (42) is used as an accumulation chamber. The grid placed inside the tray (42) can be made of a material such as stainless steel or nickel plated on steel wire.

The cooking device (10) comprises at least one control unit (60). The control unit (60) manages the operating functions of the cooking device (10). For this, the control unit (60) may be associated with the bottom plate (40), the top plate (20), the infrared heat source (21), and the movement mechanism (30). The control unit (60) is further associated with a display panel (61). The said display panel (61) allows the user to program the cooking device (10) in predetermined ways.

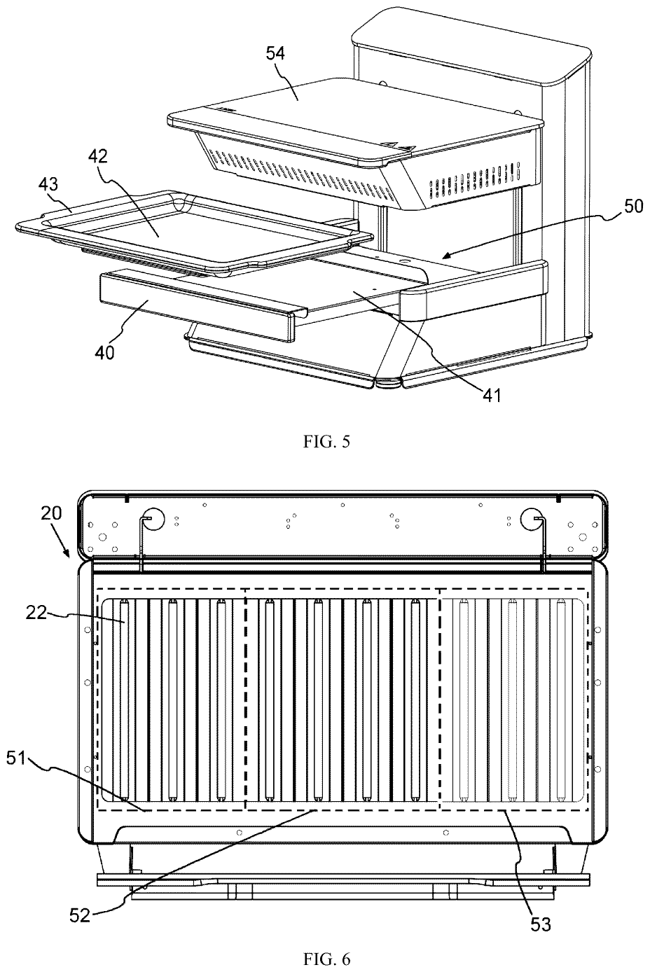

FIG. 6 shows a representative bottom view of the infrared heat source (21) in the cooking device (10) of the invention. Accordingly, the cooking device (10) has at least one cooking space (50). The cooking space (50) may be configured to operate the portion at different temperatures. For this, there is a plurality of cooking zones in the cooking space (50). In these multiple cooking zones, it is ensured that different food products can also be cooked in the cooking device (10). For this, there are 3 cooking zones in a possible embodiment of the invention in the cooking space (50). The said cooking zones are a first cooking zone (51), a second cooking zone (52), and a third cooking zone (53). In addition, there is a fourth cooking zone (54) on the top of the top plate (20). The first cooking zone (51), the second cooking zone (52), and the third cooking zone (53) are partitioned in the cooking space (50) to be heated by 3, 4, and 3 carbon filaments (22), respectively. In this way, it is ensured that different food products are cooked at the same time in different zones. These separate compartments can also be controlled separately from the display panel (61). However, the fourth cooking zone (54) is also positioned with carbon filaments (22) on top of the top plate (20). It provides heat in a way that allows the products cooked by the fourth cooking zone (54) to be kept warm. Thanks to the fact that these multiple cooking zones can be operated at separate temperatures, a multifunctional structure is obtained. By means of the control unit (60), the cooking zones can be controlled individually or all of them can be operated as a whole.

With all this embodiment, energy consumption in different foods can be reduced compared to conventional heating. Conventional cooking ovens can cause deterioration of the product surface, overheating, oxidation, roasting, low yields, difficulty in emissions, and high energy cost by using hot air convection at high speed. The cooking device (10) does not need to heat the air, maintain oven temperatures, and reduce humidity by means of its own heating system. Temperature control can be made sharper with the cooking device (10). High-temperature fluxes can be directed to the product surface with almost instantaneous control of the distributed power. As the surface temperature increases in the entire surface area of the temperature, heat is transported to the center by conduction.

Since the bottom plate (40) of the cooking device (10) of the invention is movable, the bottom plate (40) is positioned separately in the cooking position (P) and in the serving position(S), ensuring that the user needs are met. In addition, thanks to the fact that the tray (42) on the bottom plate (40) is detachable from the bottom plate (40), it is ensured that the tray (42) can be used directly during service and a new tray (42) can be used for the next operation. In addition, it is also ensured that different types of trays (42) can be used depending on the food product desired to be cooked. In addition, thanks to the fact that the bottom plate (40) can be moved relative to the top plate (20), it is possible to adjust the cooking at different temperatures and times. In addition, the cooking device (10) allows food products with different cooking times and sensitivity to be cooked at the same time through different cooking spaces (50). In addition, through the fourth cooking zone (54), it is ensured that the cooked food products are kept warm.

The protection scope of the invention is specified in the appended claims and cannot be strictly limited to those explained in this detailed description for illustrative purposes. It is clear that those skilled in the art may exhibit similar embodiments in light of the foregoing without drifting apart from the main theme of the invention.

### REFERENCE NUMBERS GIVEN IN THE FIGURE

10 Cooking Device
11 Chassis
12 Base
20 Top Plate
21 Infrared Heat Source
22 Carbon Filament
23 Reflector
30 Movement Mechanism
31 Slot
32 Skid
40 Bottom Plate
41 Tray Slot
42 Tray
43 Flank
50 Cooking Space
51 First Cooking Zone
52 Second Cooking Zone
53 Third Cooking Zone
54 Fourth Cooking Zone
60 Control Unit
61 Display Panel
(P) Cooking Position
(S) Serving Position
(I) Vertical Axis
(II) Horizontal Axis

What is claimed is:

1. A cooking device comprising at least one bottom plate and at least one top plate positioned on a chassis,
at least one infrared heat source positioned on at least one of the top plate and the bottom plate to allow heating/cooking of a food product in a cooking area,
wherein the cooking device comprises a movement mechanism where at least first one of the bottom plate and the top plate is coupled for movement in a vertical axis relative to second one of the bottom plate and the top plate; and
the bottom plate is configured to be at least partially movable on a horizontal axis (II) to be positioned in a cooking position and a serving position.

2. The cooking device according to claim 1, wherein the movement mechanism moves the bottom plate in the vertical axis.

3. The cooking device according to claim 1, wherein the cooking device comprises at least one tray slot on the bottom plate and a tray, wherein the tray is allowed to be placed in the tray slot.

4. The cooking device according to claim 3, wherein the tray is made of at least one of stainless steel, granite coating on aluminum casting, enamel coating on iron casting, heat-resistant porcelain, or ceramic.

5. The cooking device according to claim 3, wherein a grid disposed of in the tray is made of stainless steel or nickel-plated steel wire.

6. The cooking device according to claim 1, wherein the cooking device comprises at least one control unit for controlling the movement mechanism and a display panel for user guidance.
